(19) United States
(12) Patent Application Publication
(10) Pub. No.: US 2026/0228920 A1
(43) Pub. Date: Aug. 6, 2026

(54) MOBILE BODY, CALIBRATION METHOD, AND PROGRAM

(71) Applicant: SONY GROUP CORPORATION, Tokyo (JP)

(72) Inventor: Shingo TSURUMI, Tokyo (JP)

(21) Appl. No.: 18/878,898

(22) PCT Filed: Jun. 26, 2023
(86) PCT No.: PCT/JP2023/023472

§ 371 Date: Dec. 25, 2024

(30) Foreign Application Priority Data
Jul. 12, 2022 (JP) 2022-111604

(51) Int. Cl. G06T 7/80; G06T 7/593; H04N 13/239; H04N 13/246; H04N 13/398

(52) U.S. Cl. CPC G06T 7/85; G06T 7/593; H04N 13/239; H04N 13/246; H04N 13/398; G06T 2207/10012; G06T 2207/10032

(57) ABSTRACT

The present disclosure relates to a mobile body, a calibration method, and a program capable of eliminating mismatch between user calibration and calibration check. A calibration check unit executes a second calibration check to which a calibration parameter obtained by calibration of a stereo camera is applied, using a deviation detection image in which a calibration deviation is detected in a first calibration check of the stereo camera executed during the movement of a self device. The technology according to the present disclosure can be applied to, for example, a drone equipped with a stereo camera.

### TECHNICAL FIELD

The present disclosure relates to a mobile body, a calibration method, and a program, and more particularly, to a mobile body, a calibration method, and a program capable of eliminating mismatch between user calibration and calibration check.

### BACKGROUND ART

A technique is known in which a stereo camera including two left and right cameras is mounted on a mobile body such as a drone, and a distance to an object is measured on the basis of a stereo image captured by the stereo camera. Such a stereo camera requires calibration.

Patent Document 1 discloses a stereo camera calibration device that performs calibration using images of mobile calibration charts disposed at a plurality of different distances, generates a parallax correction table at each distance, and corrects parallax at the time of distance estimation. According to the technique of Patent Document 1, the accuracy of calibration can be improved, and the accuracy of distance measurement can be improved.

A general stereo camera product is shipped in a factory in a state where calibration (hereinafter, referred to as factory calibration) is performed. During use by a user, in a case where deviation in calibration is detected by calibration check, calibration (hereinafter, referred to as user calibration) is performed again under the user.

### CITATION LIST

### Patent Document

Patent Document 1: Japanese Patent Application Laid-Open No. 2014-6179

### SUMMARY OF THE INVENTION

### Problems to be Solved by the Invention

However, even though the user calibration has been performed, it may be determined that the calibration is deviated in calibration check performed immediately after the user calibration.

The present disclosure has been made in view of such a situation, and an object of the present disclosure is to eliminate mismatch between user calibration and calibration check.

### Solutions to Problems

A mobile body according to the present disclosure is a mobile body including: a stereo camera; an image saving unit that saves a deviation detection image in which a calibration deviation is detected in a first calibration check of the stereo camera executed during movement of the mobile body; and a calibration check unit that uses the deviation detection image to execute a second calibration check to which a calibration parameter obtained by calibration of the stereo camera is applied.

A calibration method of the present disclosure is a calibration method including, by a mobile body including a stereo camera: saving a deviation detection image in which a calibration deviation is detected in a first calibration check of the stereo camera executed during movement of the mobile body; and using the deviation detection image to execute a second calibration check to which a calibration parameter obtained by calibration of the stereo camera is applied.

A program of the present disclosure is a program for causing a computer to execute processing of: saving a deviation detection image in which a calibration deviation is detected in a first calibration check of a stereo camera executed during movement of the mobile body including the stereo camera; and using the deviation detection image to execute a second calibration check to which a calibration parameter obtained by calibration of the stereo camera is applied.

In the present disclosure, a deviation detection image in which a calibration deviation is detected in a first calibration check of a stereo camera executed during movement of a mobile body including the stereo camera is saved, and using the deviation detection image, a second calibration check to which a calibration parameter obtained by calibration of the stereo camera is applied is executed.

### BRIEF DESCRIPTION OF DRAWINGS

FIG. 1 is a diagram illustrating an outline of calibration according to the present disclosure.

FIG. 2 is a diagram for explaining detection of a calibration deviation.

FIG. 3 is a diagram for explaining detection of a calibration deviation.

FIG. 4 is a block diagram illustrating a configuration example of a mobile body.

FIG. 5 is a block diagram illustrating a functional configuration example of the mobile body.

FIG. 6 is a block diagram illustrating a functional configuration example of the mobile body.

FIG. 7 is a flowchart for explaining an operation of the mobile body.

FIG. 8 is a flowchart for explaining an operation of the mobile body.

FIG. 9 is a diagram illustrating a configuration example of a computer.

### MODE FOR CARRYING OUT THE INVENTION

Hereinafter, modes for carrying out the present disclosure (hereinafter referred to as embodiments) will be described. Note that the description will be made in the following order.
1. Related art and problems thereof
2. Outline of technology according to present disclosure
3. Hardware configuration and functional configuration of mobile body
4. Operation of mobile body at time of distance measurement and user calibration
5. Configuration example of computer

### 1. RELATED ART AND PROBLEMS THEREOF

A technique is known in which a stereo camera including two left and right cameras is mounted on a mobile body such as a drone, and a distance to an object is measured on the basis of a stereo image captured by the stereo camera. Such a stereo camera requires calibration.

A general stereo camera product is shipped in a factory in a state where calibration (factory calibration) is performed. During use by the user, in a case where deviation in calibration is detected by calibration check, calibration (user calibration) is performed again under the user.

As a calibration method of a stereo camera, a plurality of methods have been proposed, but a method using a calibration chart on which a checker pattern, a circle grid, or the like is printed is common.

In user calibration, a method of automatically performing calibration during use of a stereo camera without using a calibration chart has also been proposed. However, since it is difficult to ensure robustness, many products include a small calibration chart.

In a case where calibration using the calibration chart as described above is performed, it is desirable to evenly arrange the calibration chart from a short distance to a long distance within an actual distance measurement range.

However, in order to perform calibration at a long distance, a large calibration chart is required for convenience of pattern detection. Regardless of factory calibration, it is not realistic to perform calibration using a large calibration chart in user calibration.

Furthermore, in the work related to calibration, it is necessary to capture the calibration chart so that the calibration chart appears at various positions in the image, which is troublesome for the user.

Moreover, although the technique of Patent Document 1 can also be applied to factory calibration, it is not realistic to apply the technique to user calibration, and it is troublesome for the user to manually arrange calibration charts at a plurality of different distances.

From the above, in the user calibration, it is often necessary to perform only calibration at a short distance, and there is a possibility that the distance measurement accuracy at a long distance is deteriorated. For this reason, even though the user calibration is performed, it may be determined that the calibration is deviated in the calibration check when used immediately after the user calibration.

### 2. OUTLINE OF TECHNOLOGY ACCORDING TO PRESENT DISCLOSURE

In the technology according to the present disclosure, a calibration check to which a calibration parameter obtained by user calibration is applied is executed using a deviation detection image in which a deviation is detected in a calibration check during distance measurement. As a result, it is possible to eliminate the mismatch between the user calibration and the calibration check while reducing the user's trouble related to the user calibration.

### (Outline of Calibration According to Present Disclosure)

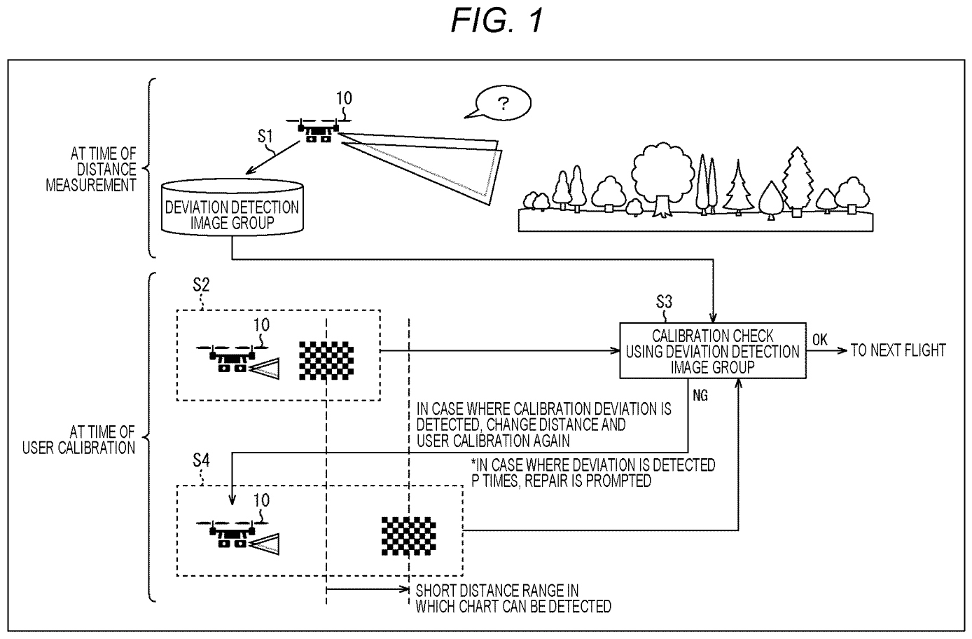

FIG. 1 is a diagram illustrating an outline of calibration according to the present disclosure.

A mobile body 10 to which the technology according to the present disclosure can be applied illustrated in FIG. 1 is configured as a drone. The mobile body 10 is equipped with a stereo camera for obstacle detection, and can fly while avoiding an obstacle by measuring a distance during flight (movement).

Here, it is assumed that an external force is applied to the stereo camera before the mobile body 10 flies, and it is detected that the calibration is deviated by the calibration check during flight. The calibration check is executed using a stereo image (left image, right image) acquired from a stereo camera during the flight of the mobile body 10.

In this case, in step S1, the stereo image (left image, right image) acquired from the stereo camera when it is detected that the calibration is deviated (hereinafter, referred to as a calibration deviation) is saved as the deviation detection image. Here, a plurality of sets of deviation detection images are acquired and saved as a deviation detection image group.

Note that, in a case where the mobile body 10 continues the flight while the calibration is deviated, there is a possibility that the distance to the obstacle is erroneously estimated and the brake is not in time. Therefore, the mobile body 10 notifies the user that user calibration is necessary after landing (stop).

That is, in step S2, the user calibration is performed by arranging the calibration chart at a predetermined short distance. In the user calibration, photographing is performed a plurality of times so that the calibration chart appears at various positions (specifically, upper, lower, left, and right sides in the image) in the image. Note that the calibration chart used for user calibration is a small calibration chart.

Thereafter, in step S3, a calibration check to which the calibration parameters obtained by the user calibration are applied is executed using the deviation detection image group. In a case where no calibration deviation is detected in the calibration check (in a case where the calibration check is OK), the next flight becomes possible.

On the other hand, in a case where a calibration deviation is detected in the calibration check (in a case where the calibration check is NG), the distance of the calibration chart is changed, and the user calibration is prompted again.

That is, in step S4, the calibration chart is arranged at a distance different from the previous distance (step S2), and the user calibration is performed again. In the user calibration again, the small calibration chart is disposed at a position farther than the previous time within a detectable short distance range.

Thereafter, in step S3 again, the calibration check to which the calibration parameter obtained by the user calibration again is applied is executed using the deviation detection image group.

Steps S3 and S4 are repeated until the calibration check is OK. However, in a case where the calibration deviation is repeatedly detected P times (a certain number of times), the user is prompted to repair the stereo camera.

### (Detection of Calibration Deviation)

In the calibration check described above, the calibration deviation is detected by the parallax of the stereo camera estimated on the basis of the stereo image.

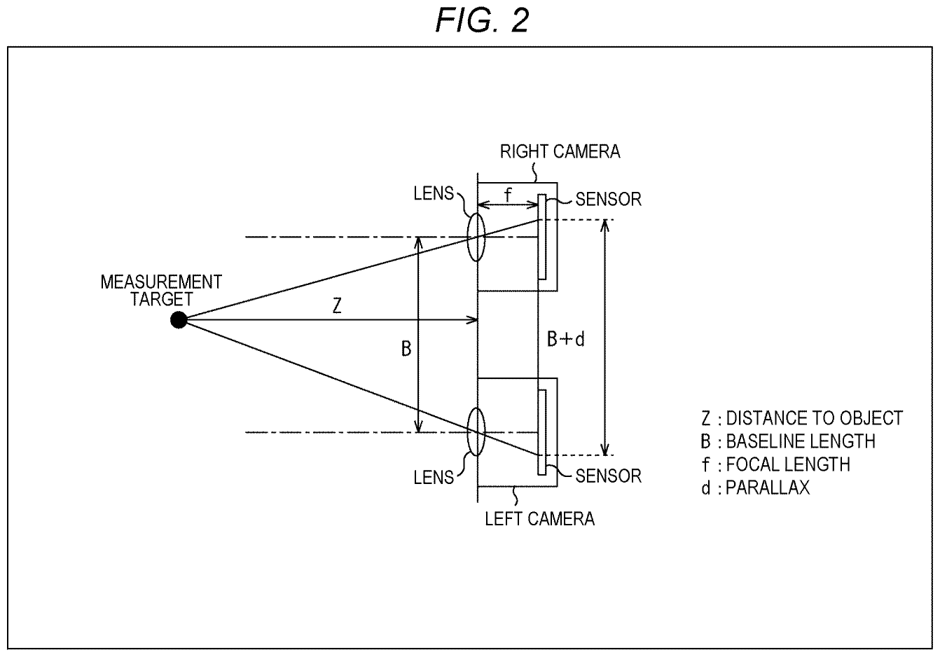

As illustrated in FIG. 2, the distance Z from the stereo camera to the measurement target (distance measurement target) is expressed as follows, where a baseline length of the left camera and the right camera constituting the stereo camera is B, a focal length is f, and the parallax obtained from the obtained stereo image (left image, right image) is d.

$$[ Math . 1 ]$$

$$Z = ( B \times f ) / d$$

Therefore, the parallax d is expressed as follows.

$$[ Math . 2 ]$$

$$d = ( B \times f ) / Z$$

In a case where the distance Z to the measurement target satisfies Z>(B×f), the disparity d is less than 1, and in the case of Z>2(B×f), the disparity d is 0 (zero) by rounding off the value to the closest whole number. That is, the stereo image obtained by capturing an image of the measurement target at a farther distance has a smaller parallax d.

On the other hand, originally, zero or positive parallax is required in the stereo image acquired from the stereo camera.

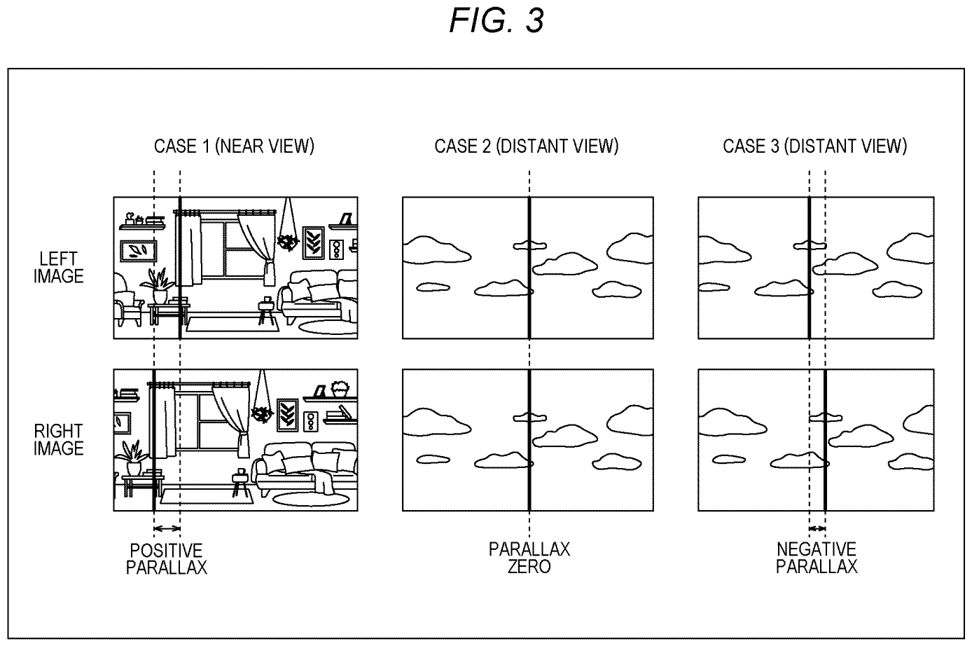

For example, as in Case 1 illustrated in FIG. 3, in a stereo image (left image, right image) obtained by capturing a near view, the parallax for a subject (room curtain) close to the stereo camera is positive.

Furthermore, as in Case 2 illustrated in FIG. 3, in the stereo image obtained by capturing a distant view, the parallax of the object (cloud floating in the sky) far from the stereo camera (at infinity) is zero (substantially zero).

However, in a case where the calibration of the stereo camera is deviated, the parallax may be negative. In particular, in a stereo image in which the original parallax is less than 1, the parallax tends to be negative even with a slight calibration deviation.

That is, as in Case 3 illustrated in FIG. 3, in a case where the parallax of the subject far from the stereo camera is negative in the stereo image obtained by capturing a distant view, it can be determined that the calibration is deviated.

Therefore, in the calibration check, as described with reference to FIG. 2, it is desirable to use a stereo image captured in a state where the distance Z to the measurement target satisfies Z>(B×f). Furthermore, since the parallax of an edge portion of a cloud floating in the sky or the like can be regarded as substantially zero, a stereo image as in Cases 2 and 3 in FIG. 3 may be detected and used by a scene recognizer or the like.

### 3. HARDWARE CONFIGURATION AND FUNCTIONAL CONFIGURATION OF MOBILE BODY

Hereinafter, a hardware configuration and a functional configuration of the mobile body 10 to which the technology according to the present disclosure is applied will be described.

### (Hardware Configuration of Mobile Body)

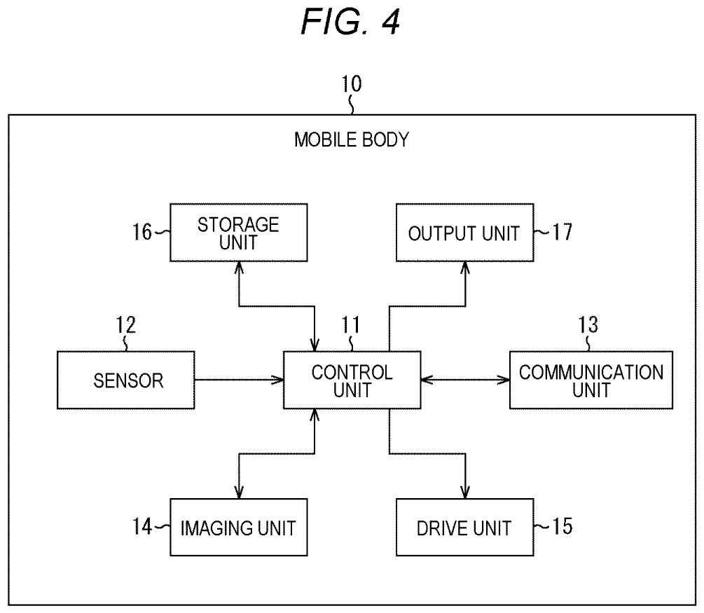

FIG. 4 is a block diagram illustrating a hardware configuration example of the mobile body 10.

As described above, the mobile body 10 is configured by a drone, but is not limited thereto, and may be configured by another flying object, a vehicle (automobile), a ship, an autonomous mobile robot such as an autonomous mobile cleaner, or the like. The mobile body 10 includes a control unit 11, a sensor 12, a communication unit 13, an imaging unit 14, a drive unit 15, a storage unit 16, and an output unit 17.

The control unit 11 includes a central processing unit (CPU), a memory, and the like, and executes a predetermined program to control the communication unit 13, the imaging unit 14, the drive unit 15, the storage unit 16, and the output unit 17.

The sensor 12 includes various sensors including an image sensor constituting a stereo camera, and senses an environment around the mobile body 10 including a traveling direction of the mobile body 10. By sensing the environment around the mobile body 10, estimation of the self-position and posture of the mobile body 10 is realized.

The communication unit 13 includes a network interface or the like, and performs wireless or wired communication with a notebook PC, a tablet terminal, a propo (controller), or a smartphone operated by a user who operates and controls the mobile body 10. The communication unit 13 can transmit, for example, presentation information to a propo operated by the user or the like regarding a result of a calibration check during distance measurement or a calibration check after user calibration.

The imaging unit 14 includes a gimbal camera or the like, and performs photographing under the control of the control unit 11.

The drive unit 15 is a mechanism for moving the mobile body 10, and includes a flight mechanism, a traveling mechanism, a propulsion mechanism, and the like. In this example, the mobile body 10 is configured as a drone, and the drive unit 15 is configured by a motor, a propeller, or the like as a flight mechanism. Furthermore, in a case where the mobile body 10 is configured as a vehicle, the drive unit 15 is configured by wheels or the like as a traveling mechanism, and in a case where the mobile body 10 is configured as a ship, the drive unit 15 is configured by a screw propeller or the like as a propulsion mechanism. The drive unit 15 is driven according to the control of the control unit 11 to move the mobile body 10.

The storage unit 16 includes a nonvolatile memory such as a flash memory, and stores a deviation detection image, various types of information used for calibration, and the like under the control of the control unit 11.

The output unit 17 includes a display unit such as a light emitting diode (LED) lamp or a small liquid crystal display provided on the surface of the main body of the mobile body 10, a speaker that outputs sound such as a warning sound or synthesized sound, and the like. The output unit 17 can output, for example, presentation information to the user regarding a result of calibration check during distance measurement or calibration check after user calibration.

In the mobile body 10 configured in this manner, a calibration check during distance measurement (during flight) and a calibration check after user calibration are executed.

### (Functional Configuration Example of Mobile Body)

Next, a functional configuration example of the mobile body 10 realized by the control unit 11 will be described.

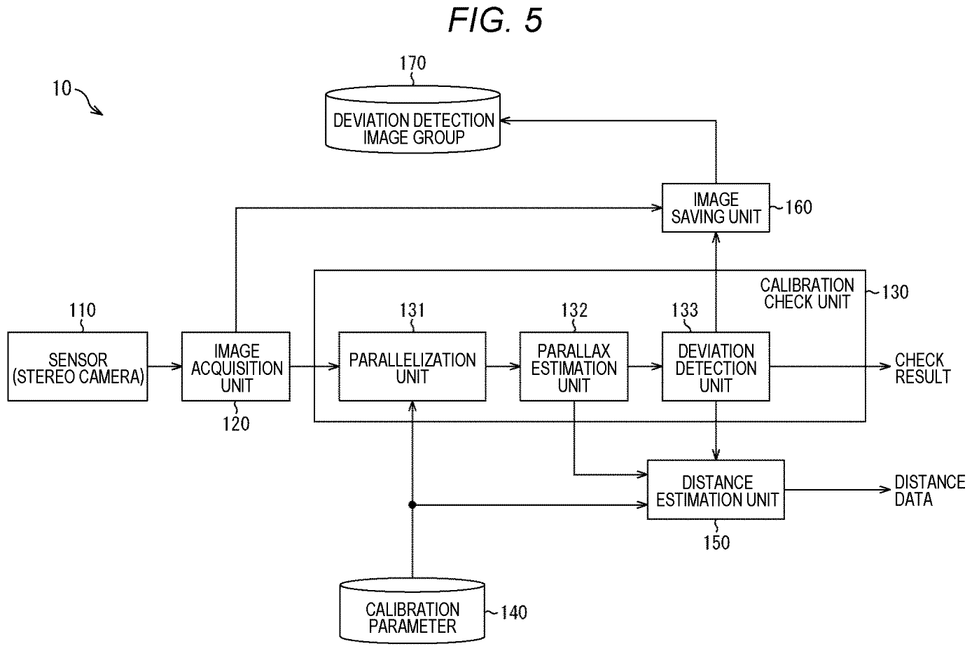

FIG. 5 is a block diagram illustrating a functional configuration example of the mobile body 10 that can be realized during distance measurement of the mobile body 10.

The mobile body 10 illustrated in FIG. 5 includes a sensor 110, an image acquisition unit 120, a calibration check unit 130, a calibration parameter storage unit 140, a distance estimation unit 150, an image saving unit 160, and a deviation detection image group storage unit 170.

The image acquisition unit 120, the calibration check unit 130, the distance estimation unit 150, and the image saving unit 160 are implemented by the control unit 11 executing a predetermined program. Furthermore, the calibration parameter storage unit 140 and the deviation detection image group storage unit 170 are implemented by the storage unit 16.

The sensor 110 includes an image sensor of a stereo camera (left camera, right camera) mounted on the mobile body 10, and captures a stereo image (left image, right image). During distance measurement (during flight), a stereo image may be captured at regular time intervals, or a stereo image may be captured at a timing according to an instruction from a propo operated by the user or the like.

The image acquisition unit 120 acquires a stereo image captured by the sensor 110, and supplies the stereo image to the calibration check unit 130 and the image saving unit 160.

The calibration check unit 130 performs calibration check of the stereo camera using the stereo image acquired by the image acquisition unit 120. The calibration check unit 130 includes a parallelization unit 131, a parallax estimation unit 132, and a deviation detection unit 133.

The parallelization unit 131 parallelizes the stereo image (left image, right image) using the calibration parameters stored in the calibration parameter storage unit 140. The calibration parameters here are camera parameters set in advance, and are, for example, internal parameters and external parameters of the stereo camera obtained by factory calibration.

The parallax estimation unit 132 estimates the parallax of the stereo camera on the basis of the parallelized stereo image (left image, right image). In the parallax estimation of the stereo camera, a method using block matching, a deep neural network (DNN), or the like can be adopted. The estimated parallax of the stereo camera is supplied to the deviation detection unit 133 and the distance estimation unit 150.

The deviation detection unit 133 detects a calibration deviation on the basis of the parallax of the stereo camera estimated by the parallax estimation unit 132. Specifically, as described with reference to FIG. 3, the deviation detection unit 133 detects the calibration deviation in the horizontal direction at least in a case where the estimated parallax of the stereo camera is a negative parallax. Furthermore, even in a case where the estimated parallax of the stereo camera is a positive parallax, the deviation detection unit 133 may detect the calibration deviation by determining that the parallax mismatch occurs on the basis of the object whose self-position and size are known.

The presence or absence of the detection of the calibration deviation is output as a check result of a calibration check. In a case where the calibration deviation is not detected, information to that effect is supplied to the distance estimation unit 150. Furthermore, in a case where a calibration deviation is detected, information to that effect is supplied to the image saving unit 160.

The distance estimation unit 150 estimates the distance using the estimated parallax of the stereo camera and the calibration parameter of the calibration parameter storage unit 140 on the basis of the information that no calibration deviation has been detected supplied from the deviation detection unit 133.

The image saving unit 160 saves the stereo image from the image acquisition unit 120 as a deviation detection image in the deviation detection image group storage unit 170 on the basis of the information that the calibration deviation has been detected supplied from the deviation detection unit 133. That is, the deviation detection image saved in the deviation detection image group storage unit 170 is a stereo image before parallelization in which the calibration deviation is detected.

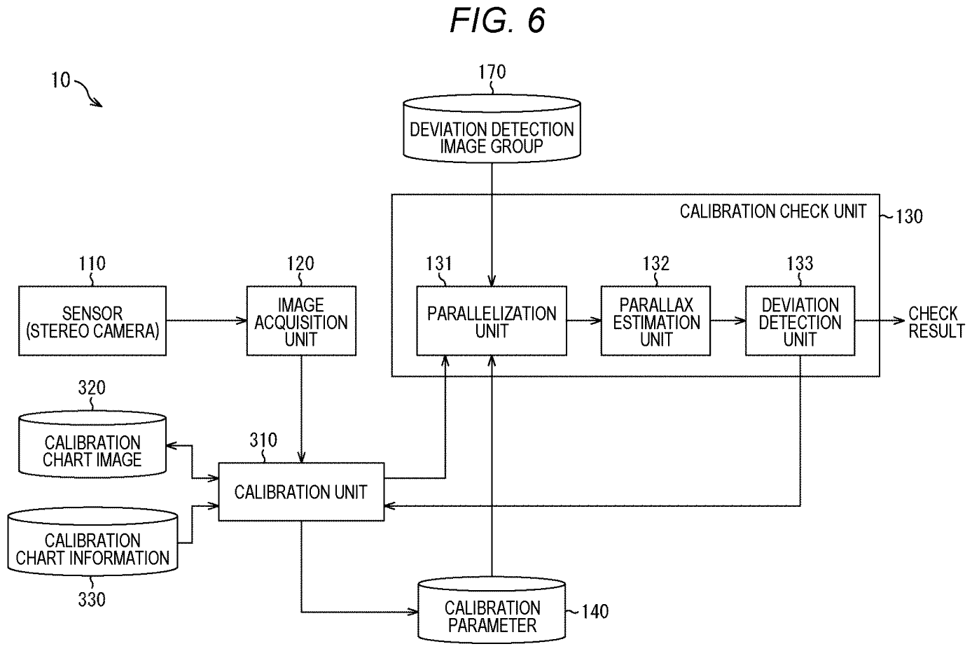

FIG. 6 is a block diagram illustrating a functional configuration example of the mobile body 10 realized at the time of user calibration of the mobile body 10.

The mobile body 10 illustrated in FIG. 6 includes the sensor 110, the image acquisition unit 120, the calibration check unit 130, the calibration parameter storage unit 140, the deviation detection image group storage unit 170, a calibration unit 310, a calibration chart image storage unit 320, and a calibration chart information storage unit 330.

In the mobile body 10 illustrated in FIG. 6, the same functional blocks as the functional blocks constituting the mobile body 10 illustrated in FIG. 5 are denoted by the same reference signs.

The calibration unit 310 is implemented by the control unit 11 executing a predetermined program. Furthermore, the calibration chart image storage unit 320 and the calibration chart information storage unit 330 are implemented by the storage unit 16.

At the time of user calibration, the sensor 110 photographs a calibration chart arranged at a predetermined short distance. Then, the image acquisition unit 120 acquires the stereo image captured by the sensor 110 and supplies the stereo image to the calibration unit 310.

The calibration unit 310 performs user calibration by using a stereo image obtained by capturing an image of a calibration chart and calibration chart information related to the captured calibration chart. The stereo image obtained by photographing the calibration chart is accumulated as a calibration chart image in the calibration chart image storage unit 320. The calibration chart information is information representing the type, size, interval, and the like of the pattern printed on the calibration chart, and is registered in advance in the calibration chart information storage unit 330.

The calibration parameter obtained as a result of the user calibration is temporarily supplied to the calibration check unit 130.

The calibration check unit 130 uses the deviation detection image group saved in the deviation detection image group storage unit 170 to execute a calibration check of the stereo camera to which the calibration parameters obtained by the user calibration are applied.

Specifically, the parallelization unit 131 performs parallelization processing for each of a plurality of sets of deviation detection images (left image, right image) using the calibration parameters from the calibration unit 310. The parallax estimation unit 132 estimates the parallax of the stereo camera on the basis of the parallelized deviation detection image (left image, right image). The deviation detection unit 133 detects a calibration deviation on the basis of the parallax of the stereo camera estimated by the parallax estimation unit 132.

The presence or absence of the detection of the calibration deviation is output as a check result of a calibration check. In a case where the calibration deviation is detected, information to that effect is supplied to the calibration unit 310. In this case, the calibration unit 310 performs recalibration using a calibration chart arranged at a distance different from the previous distance. In the recalibration, in addition to the newly captured stereo image, the calibration chart image used in the previous calibration is used.

### 4. OPERATION OF MOBILE BODY AT TIME OF DISTANCE MEASUREMENT AND USER CALIBRATION

Hereinafter, the operation of the mobile body 10 at the time of distance measurement and user calibration will be described.

### (Operation of Mobile Body at Time of Distance Measurement)

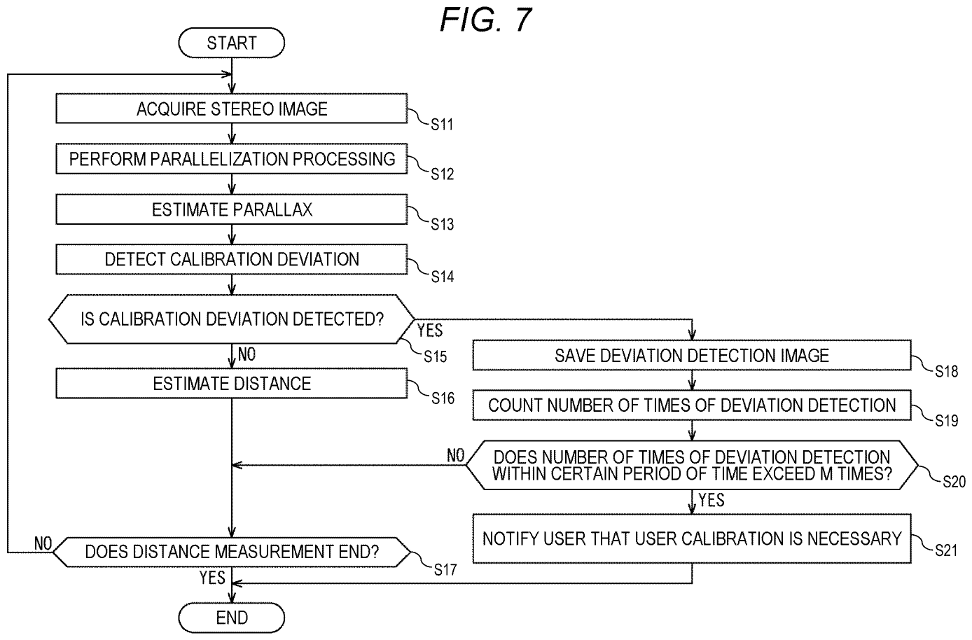

First, the operation of the mobile body 10 at the time of distance measurement (during flight) will be described with reference to the flowchart of FIG. 7.

In step S11, the image acquisition unit 120 acquires a stereo image captured by the sensor 110.

In step S12, the parallelization unit 131 performs parallelization processing on the stereo image using the calibration parameters stored in the calibration parameter storage unit 140.

In step S13, the parallax estimation unit 132 estimates the parallax of the stereo camera on the basis of the parallelized stereo image.

In step S14, the deviation detection unit 133 detects a calibration deviation on the basis of the parallax of the stereo camera estimated by the parallax estimation unit 132.

In step S15, the deviation detection unit 133 determines whether a calibration deviation is detected.

In a case where it is determined in step S15 that no calibration deviation is detected, the process proceeds to step S16.

In step S16, the distance estimation unit 150 estimates the distance using the estimated parallax of the stereo camera and the calibration parameter in the calibration parameter storage unit 140.

Thereafter, the process proceeds to step S17, and the control unit 11 (FIG. 4) determines whether or not the distance measurement ends, that is, whether or not the scheduled flight ends. In a case where it is determined that the distance measurement does not end, the process returns to step S11, and the subsequent processing is repeated. In a case where it is determined that the distance measurement ends, the mobile body 10 ends the flight, and the process ends.

On the other hand, in a case where it is determined in step S15 that the calibration deviation is detected, the process proceeds to step S18.

In step S18, the image saving unit 160 saves the stereo image in which the calibration deviation is detected as a deviation detection image in the deviation detection image group storage unit 170.

In step S19, the deviation detection unit 133 counts the number of times of deviation detection. That is, the number of times of deviation detection is incremented by one.

In step S20, the deviation detection unit 133 determines whether or not the number of times of deviation detection within a certain period of time exceeds a certain number of M times.

In a case where it is determined in step S20 that the number of times of deviation detection within the certain period of time does not exceed M times, the process proceeds to step S17, and it is determined whether or not the distance measurement ends.

On the other hand, in a case where it is determined in step S20 that the number of times of deviation detection within the certain period of time exceeds M times, the process proceeds to step S21.

In step S21, the mobile body 10 notifies the user that user calibration of the stereo camera is necessary, and ends the flight. Specifically, the calibration check unit 130 generates notification information for notifying that user calibration is necessary. Then, the communication unit 13 transmits the notification information to a propo operated by the user or the like, and the output unit 17 outputs the notification information, so that the user is notified that the user calibration is necessary.

As described above, in a case where the calibration deviation is detected at the time of the distance measurement, M sets of stereo images before parallelization when the calibration deviation is detected are saved as a deviation detection image group.

### (Operation of Mobile Body at Time of User Calibration)

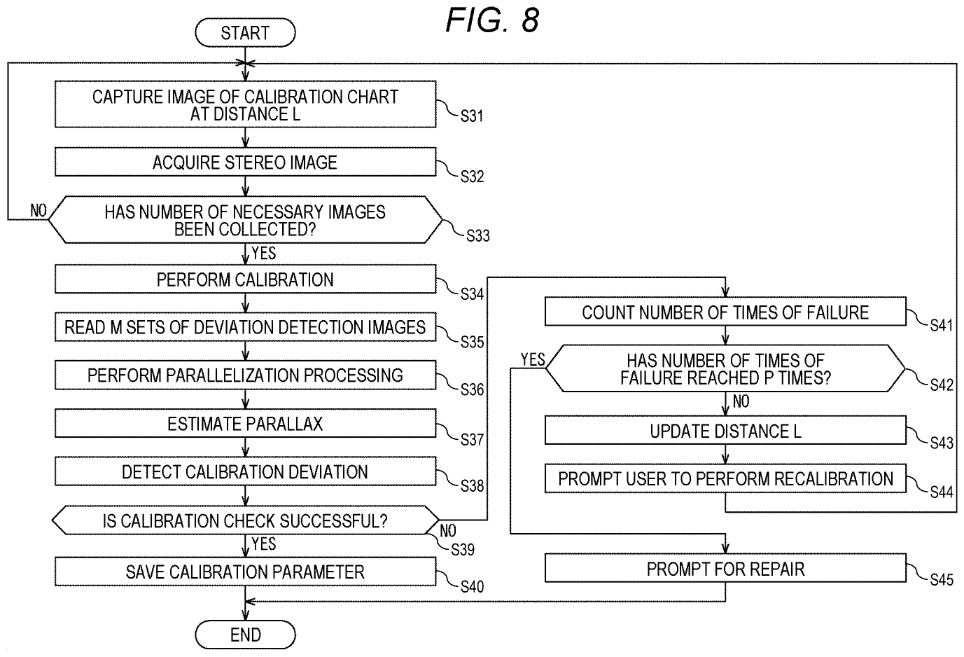

Next, the operation of the mobile body 10 at the time of the user calibration will be described with reference to the flowchart of FIG. 8. The process of FIG. 8 is started in a state where the calibration chart is disposed at a position of a distance L from the mobile body 10 (stereo camera).

In step S31, the sensor 110 captures an image of the calibration chart at the distance L.

In step S32, the image acquisition unit 120 acquires a stereo image captured by the sensor 110. The calibration unit 310 accumulates the stereo image acquired by the image acquisition unit 120 in the calibration chart image storage unit 320 as a calibration chart image.

In step S33, the calibration unit 310 determines whether or not the number of images necessary for calibration has been collected.

In a case where it is determined in step S33 that the necessary number of images has not been collected, the process returns to step S31, and the capturing an image of the calibration chart and the acquisition of the stereo image are repeated.

On the other hand, in a case where it is determined in step S33 that the necessary number of images has been collected, the process proceeds to step S34.

In step S34, the calibration unit 310 extracts feature points from the accumulated calibration chart image, and uses the calibration chart information registered in the calibration chart information storage unit 330 to calibrate the stereo camera. As a result, a new calibration parameter is obtained.

In step S35, the calibration check unit 130 reads M sets of deviation detection images saved in the deviation detection image group storage unit 170.

In step S36, the parallelization unit 131 performs parallelization processing on the M sets of deviation detection images read from the deviation detection image group storage unit 170 using the calibration parameter obtained by the calibration.

In step S37, the parallax estimation unit 132 estimates the parallax of the stereo camera on the basis of the parallelized M sets of deviation detection images.

In step S38, the deviation detection unit 133 detects a calibration deviation on the basis of the parallax of the stereo camera estimated by the parallax estimation unit 132.

In step S39, the calibration check unit 130 determines whether or not the calibration check is successful. Specifically, the calibration check unit 130 determines whether or not the number of sets of deviation detection images in which a calibration deviation is detected in the calibration check among the M sets of deviation detection images has exceeded N (N<M).

In a case where it is determined in step S39 that the number of sets of deviation detection images in which the calibration deviation is detected has not exceeded N, that is, in a case where the calibration check has succeeded, the process proceeds to step S40.

In step S40, the calibration unit 310 saves the calibration parameter obtained by the calibration in the calibration parameter storage unit 140, and the process ends. As a result, the mobile body 10 can resume the flight without a calibration deviation.

On the other hand, in a case where it is determined in step S39 that the number of sets of deviation detection images in which the calibration deviation is detected exceeds N, the calibration check unit 130 determines that the calibration check has failed, and the process proceeds to step S41.

In step S41, the calibration check unit 130 counts the number of times of failure. That is, the number of times of failure is incremented by one.

In step S42, the calibration check unit 130 determines whether or not the number of times of failure has reached P times, which is a certain number of times.

In a case where the number of times of failure is not P times (not exceeding P times) in step S42, the process proceeds to step S43, and the calibration check unit 130 updates the distance L to the position where the calibration chart is disposed. The updated distance L is a distance at which the calibration chart is disposed at a position farther than the previous one.

In step S44, the mobile body 10 prompts the user to perform recalibration of the stereo camera. Specifically, the calibration check unit 130 generates guidance information (to prompt the user) to request recalibration at the distance L from the calibration chart different from the previous calibration. Then, the communication unit 13 transmits the guidance information to a propo operated by the user or the like, and the output unit 17 outputs the guidance information, so that recalibration is prompted to the user.

Thereafter, the process returns to step S31, and the subsequent processing is repeated.

On the other hand, in a case where the number of times of failure is P times (has reached P times) in step S42, the process proceeds to step S45.

In step S45, the mobile body 10 prompts the user to repair the stereo camera, and the process ends. Specifically, the calibration check unit 130 generates guide information (to prompt the user) to request repair of the stereo camera. Then, the communication unit 13 transmits the guide information to a propo operated by the user or the like, and the output unit 17 outputs the guide information, so that the user is prompted to repair the stereo camera.

According to the above process, the calibration check to which the calibration parameter obtained by the user calibration is applied is executed using the deviation detection image in which the deviation is detected in the calibration check at the time of the distance measurement. As a result, it is possible to eliminate the mismatch between the user calibration and the calibration check while reducing the user's trouble related to the user calibration.

Note that, in the above description, the calibration check to which the calibration parameter obtained by the user calibration is applied is executed using the deviation detection image. The present disclosure is not limited to this, and in a factory, a calibration check to which a calibration parameter obtained by factory calibration is applied may be executed using a deviation detection image. This makes it possible to further improve the accuracy of calibration before shipment.

### 5. CONFIGURATION EXAMPLE OF COMPUTER

The series of processing described above can be performed by hardware or by software. In a case where the series of processes is performed by software, a program forming the software is installed into a computer. Here, examples of the computer include a computer incorporated in dedicated hardware, and for example, a general-purpose personal computer capable of executing various functions by installing various programs or the like.

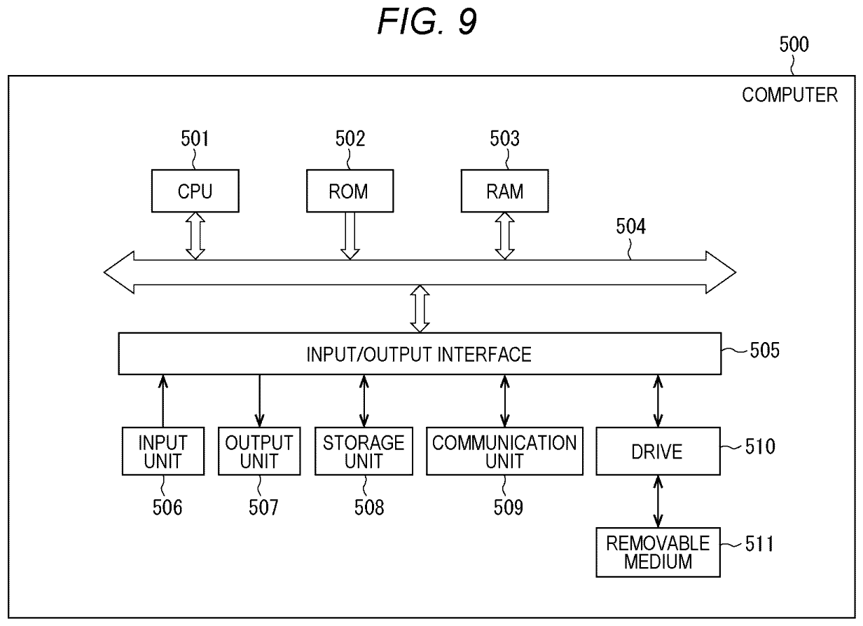

FIG. 9 is a block diagram illustrating a configuration example of the hardware of the computer, which executes the above-described series of processes by the program.

In a computer 500, a CPU 501, a read only memory (ROM) 502, and a random access memory (RAM) 503 are mutually connected by a bus 504.

An input/output interface 505 is further connected to the bus 504. An input unit 506, an output unit 507, a storage unit 508, a communication unit 509, and a drive 510 are connected to the input/output interface 505.

The input unit 506 includes a keyboard, a mouse, a microphone, and the like. The output unit 507 includes a display, a speaker, and the like. The storage unit 508 includes a hard disk, a non-volatile memory and the like. The communication unit 509 includes, for example, a network interface and the like. The drive 510 drives a removable medium 511 such as a magnetic disk, an optical disk, a magneto-optical disk, or a semiconductor memory.

In the computer 500 configured as described above, for example, the CPU 501 loads a program stored in the storage unit 508 into the RAM 503 via the input/output interface 505 and the bus 504 and executes the program, whereby the above-described series of processing is performed.

The program executed by the computer 500 (CPU 501) can be provided by being recorded in the removable medium 511 as a package medium or the like, for example. Furthermore, the program can be provided via a wired or wireless transmission medium such as a local area network, the Internet, or digital satellite broadcasting.

In the computer 500, the program can be installed in the storage unit 508 via the input/output interface 505 by attaching the removable medium 511 to the drive 510. Furthermore, the program may be received by the communication unit 509 through the wired or wireless transmission medium to be installed on the storage unit 508. In addition, the program can be installed in the ROM 502 or the storage unit 508 in advance.

Note that the program executed by the computer may be a program that performs processing in a time series according to an order described in the present specification, or may be a program that performs processing in parallel or at necessary timing such as when a call is made.

The embodiments of the present disclosure are not limited to the above-described embodiments, and various modifications can be made without departing from the gist of the present disclosure.

The effects described in the present specification are merely examples and are not limited, and other effects may be provided.

Moreover, the technology according to the present disclosure can have the following configurations.

(1)

A mobile body including:
a stereo camera;
an image saving unit that saves a deviation detection image in which a calibration deviation is detected in a first calibration check of the stereo camera executed during movement of the mobile body; and
a calibration check unit that uses the deviation detection image to execute a second calibration check to which a calibration parameter obtained by calibration of the stereo camera is applied.
   (2)

The mobile body according to (1), in which
the calibration check unit generates guide information for requesting recalibration in a case where the calibration deviation is detected in the second calibration check.
   (3)

The mobile body according to (2), in which
the calibration check unit generates the guidance information for requesting the recalibration at a distance from a calibration chart different from the calibration at a previous time.
   (4)

The mobile body according to (2) or (3), in which
the calibration check unit determines that the second calibration check has failed and generates the guide information in a case where, among a plurality of the deviation detection images, a number of the deviation detection images in which the calibration deviation is detected in the second calibration check exceeds a predetermined number.
   (5)

The mobile body according to (4), in which
the calibration check unit repeatedly generates the guidance information while a number of times of failure of the second calibration check does not exceed a certain number of times.
   (6)

The mobile body according to (5), in which
the calibration check unit generates guide information for requesting repair of the stereo camera in a case where the number of times of failure of the second calibration check reaches the certain number of times.
   (7)

The mobile body according to any one of (1) to (6), in which
the calibration check unit includes:
   a parallelization unit that performs parallelization processing on a stereo image;
   a parallax estimation unit that estimates parallax of the stereo camera on the basis of the parallelized stereo image; and
   a deviation detection unit that detects the calibration deviation on the basis of the estimated parallax.
      (8)

The mobile body according to (7), in which
the calibration check unit executes the first calibration check using the stereo image acquired from the stereo camera during movement of the mobile body.
   (9)

The mobile body according to (8), in which
in a case where the calibration deviation is detected in the first calibration check, the image saving unit saves the stereo image before parallelization as the deviation detection image.
   (10)

The mobile body according to (9), in which
the calibration check unit generates notification information for notifying that the calibration is necessary in a case where a number of times of the first calibration check in which the calibration deviation is detected within a certain period of time exceeds a certain number of times.
   (11)

The mobile body according to (8), further including
a distance estimation unit that estimates a distance using the estimated parallax and the calibration parameter set in advance in a case where the calibration deviation is not detected in the first calibration check.
   (12)

The mobile body according to any one of (7) to (11), in which
the deviation detection unit detects the calibration deviation at least in a case where the estimated parallax is a negative parallax.
   (13)

The mobile body according to any one of (1) to (12), further including
a communication unit that transmits presentation information regarding a result of the first calibration check or the second calibration check to a controller that controls the mobile body.
   (14)

The mobile body according to any one of (1) to (12), further including
an output unit that outputs presentation information regarding a result of the first calibration check or the second calibration check.
   (15)

A calibration method including, by a mobile body including a stereo camera:
saving a deviation detection image in which a calibration deviation is detected in a first calibration check of the stereo camera executed during movement of the mobile body; and
using the deviation detection image to execute a second calibration check to which a calibration parameter obtained by calibration of the stereo camera is applied.
   (16)

A program for causing a computer to execute processing of:
saving a deviation detection image in which a calibration deviation is detected in a first calibration check of a stereo camera executed during movement of the mobile body including the stereo camera; and
using the deviation detection image to execute a second calibration check to which a calibration parameter obtained by calibration of the stereo camera is applied.

### REFERENCE SIGNS LIST

10 Mobile body
11 Control unit
12 Sensor
13 Communication unit
14 Imaging unit
15 Drive unit
16 Storage unit
17 Output unit
110 Sensor
120 Image acquisition unit
130 Calibration check unit
131 Parallelization unit
132 Parallax estimation unit
133 Deviation detection unit
140 Calibration parameter storage unit
150 Distance estimation unit
160 Image saving unit
170 Deviation detection image group storage unit
310 Calibration unit
320 Calibration chart image storage unit
330 Calibration chart information storage unit

What is claimed is:

1. A mobile body comprising:
a stereo camera;
an image saving unit that saves a deviation detection image in which a calibration deviation is detected in a first calibration check of the stereo camera executed during movement of the mobile body; and
a calibration check unit that uses the deviation detection image to execute a second calibration check to which a calibration parameter obtained by calibration of the stereo camera is applied.

2. The mobile body according to claim 1, wherein
the calibration check unit generates guide information for requesting recalibration in a case where the calibration deviation is detected in the second calibration check.

3. The mobile body according to claim 2, wherein
the calibration check unit generates the guidance information for requesting the recalibration at a distance from a calibration chart different from the calibration at a previous time.

4. The mobile body according to claim 2, wherein
the calibration check unit determines that the second calibration check has failed and generates the guide information in a case where, among a plurality of the deviation detection images, a number of the deviation detection images in which the calibration deviation is detected in the second calibration check exceeds a predetermined number.

5. The mobile body according to claim 4, wherein
the calibration check unit repeatedly generates the guidance information while a number of times of failure of the second calibration check does not exceed a certain number of times.

6. The mobile body according to claim 5, wherein
the calibration check unit generates guide information for requesting repair of the stereo camera in a case where the number of times of failure of the second calibration check reaches the certain number of times.

7. The mobile body according to claim 1, wherein
the calibration check unit includes:
a parallelization unit that performs parallelization processing on a stereo image;
a parallax estimation unit that estimates parallax of the stereo camera on a basis of the parallelized stereo image; and
a deviation detection unit that detects the calibration deviation on a basis of the estimated parallax.

8. The mobile body according to claim 7, wherein
the calibration check unit executes the first calibration check using the stereo image acquired from the stereo camera during movement of the mobile body.

9. The mobile body according to claim 8, wherein
in a case where the calibration deviation is detected in the first calibration check, the image saving unit saves the stereo image before parallelization as the deviation detection image.

10. The mobile body according to claim 9, wherein
the calibration check unit generates notification information for notifying that the calibration is necessary in a case where a number of times of the first calibration check in which the calibration deviation is detected within a certain period of time exceeds a certain number of times.

11. The mobile body according to claim 8, further comprising
a distance estimation unit that estimates a distance using the estimated parallax and the calibration parameter set in advance in a case where the calibration deviation is not detected in the first calibration check.

12. The mobile body according to claim 7, wherein
the deviation detection unit detects the calibration deviation at least in a case where the estimated parallax is a negative parallax.

13. The mobile body according to claim 1, further comprising
a communication unit that transmits presentation information regarding a result of the first calibration check or the second calibration check to a controller that controls the mobile body.

14. The mobile body according to claim 1, further comprising
an output unit that outputs presentation information regarding a result of the first calibration check or the second calibration check.

15. A calibration method comprising, by a mobile body including a stereo camera:
saving a deviation detection image in which a calibration deviation is detected in a first calibration check of the stereo camera executed during movement of the mobile body; and
using the deviation detection image to execute a second calibration check to which a calibration parameter obtained by calibration of the stereo camera is applied.

16. A program for causing a computer to execute processing of:
saving a deviation detection image in which a calibration deviation is detected in a first calibration check of a stereo camera executed during movement of the mobile body including the stereo camera; and
using the deviation detection image to execute a second calibration check to which a calibration parameter obtained by calibration of the stereo camera is applied.
